(19) United States
(12) Patent Application Publication
(10) Pub. No.: US 2024/0320819 A1
(43) Pub. Date: Sep. 26, 2024

(54) INSPECTION APPARATUS, INSPECTION SYSTEM, INSPECTION METHOD AND STORAGE MEDIUM

(71) Applicant: CANON KABUSHIKI KAISHA, Tokyo (JP)

(72) Inventor: SHUN NAKAMURA, Kanagawa (JP)

(21) Appl. No.: 18/614,440

(22) Filed: Mar. 22, 2024

(30) Foreign Application Priority Data
Mar. 24, 2023 (JP) 2023-048477

(51) Int. Cl. G06T 7/00; H04N 1/00

(52) U.S. Cl. CPC G06T 7/001; H04N 1/00015; G06T 2207/30144

(57) ABSTRACT

In an inspection system of a printed material, it is made possible to deal with both an image defect and a data defect. An inspection apparatus performing inspection of a printed material output from a printing apparatus detects an image defect by collating an inspection image, which is to be inspected, obtained by reading the printed material with a reference image taken as a reference of the inspection, which corresponds to the printed material. Furthermore, the inspection apparatus detects a data defect by collating specific data extracted from the inspection image with correct data corresponding to the specific data set in advance.

### BACKGROUND

### Field

The present disclosure relates to control of an inspection system inspecting a printed material.

### Description of the Related Art

An inspection system is known, which inspects a defect (image defect), such as soling and a thin spot, in an image (pictorial pattern) formed on a sheet by reading a printed material output from a printing apparatus. Japanese Patent Laid-Open No. 2019-084770 has proposed a technique to make an attempt to achieve recovery in a case where an image defect is detected by the inspection system such as this by automatically performing printing and/or inspection again for a page of a printed material relating to the detection and further automatically correcting the portion of the image defect as needed.

The technique described in Japanese Patent Laid-Open No. 2019-084770 described above is effective as a recovery method in a case where an image defect is detected, which occurs in the printing process, but it is not possible to deal with a defect (data defect) of the input data itself, which is the source of a printed material.

### SUMMARY

According to features of the present disclosure, it is possible to deal with a defect (data defect) of the input data itself, which is the source of a printed material, for example, such as a missing page, inconsistency between the obverse side and the reverse side, and an allocation miss in page-imposition. The present disclosure has been made in view of this point. The inspection apparatus according to embodiments of the present disclosure is an inspection apparatus configured to perform inspection of a printed material output from a printing apparatus and including: one or more memories storing instructions; and one or more processors, wherein the instructions, when executed by the one or more processors, cause the inspection apparatus to perform: obtaining an inspection image which is to be inspected by reading the printed material; detecting an image defect by first collation collating a reference image taken as a reference of the inspection, which corresponds to the printed material, with the inspection image; and detecting a data defect by second collation collating specific data extracted from the inspection image with correct data corresponding to the specific data set in advance.

Further features of the present disclosure will become apparent from the following description of exemplary embodiments with reference to the attached drawings.

### BRIEF DESCRIPTION OF THE DRAWINGS

FIG. 1 is a diagram showing a configuration example of an inspection system and peripheral devices thereof;

FIG. 2 is a diagram showing a hardware configuration example of an image forming apparatus;

FIG. 3 is a diagram showing an internal configuration example of a printer unit;

FIG. 4A is a diagram showing an internal configuration example of an inspection apparatus and FIG. 4B is a top diagram showing the portion of a conveyance belt;

FIG. 5 is a diagram showing an internal configuration example of an inspection apparatus control unit;

FIG. 6 is a flowchart showing a rough flow of the operation in the inspection apparatus;

FIG. 7 is a flowchart showing details of inspection setting processing;

FIG. 8A is a diagram showing one example of an inspection setting screen;

FIG. 8B is a diagram showing one example of the inspection setting screen;

FIG. 8C is a diagram showing one example of the inspection setting screen;

FIG. 9 is a diagram showing one example of an inspection area list screen;

FIG. 10 is a flowchart showing details of inspection processing according to a first embodiment;

FIG. 11 is a diagram showing one example of an inspection results display screen;

FIG. 12 is a flowchart showing details of inspection processing according to a second embodiment;

FIG. 13 is a flowchart showing details of recovery possibility determination processing; and

FIG. 14A and FIG. 14B are each a diagram putting together the results of the recovery possibility determination processing.

### DESCRIPTION OF THE EMBODIMENTS

In the following, embodiments according to the present disclosure are explained with reference to the drawings. The following embodiments are not intended to limit the present disclosure and all combinations of features explained in each embodiment are not necessarily indispensable. Explanation is given by attaching the same symbol to the same configuration.

### First Embodiment

### <System Configuration>

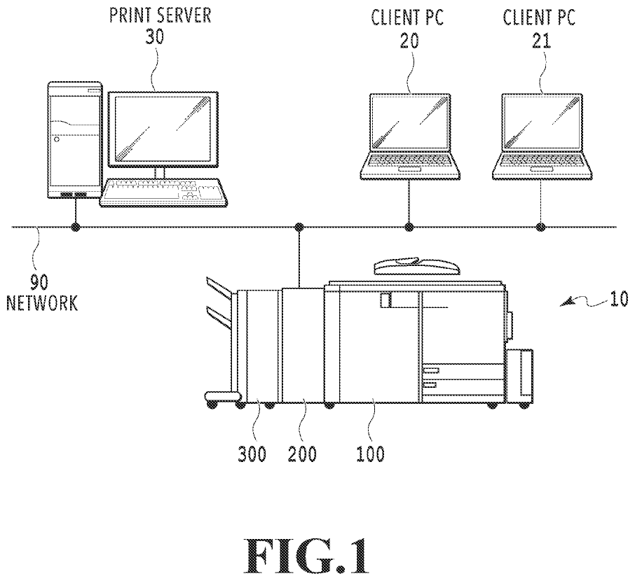

FIG. 1 is a diagram showing a configuration example of an inspection system of a printed material and peripheral devices thereof according to the present embodiment. An in-line inspection system 10 has a function to perform printing (image formation), image inspection, and finishing integrally and comprises an image forming apparatus (printing apparatus) 100, an inspection apparatus 200, and a finisher 300. The image forming apparatus 100 outputs a printed material by performing print processing based on input data (image data taken as a target of print processing). The inspection apparatus 200 receives a printed material output from the image forming apparatus 100 and inspects the printed material. The finisher 300 performs finishing processing, such as stapling and punching, as needed for the printed material inspected in the inspection apparatus 200 and discharges the printed material onto a predetermined tray. The image forming apparatus 100 is connected with an external print server 30 and client PCs 20/21 via a network 40, for example, such as a LAN. The inspection apparatus 200 is connected with the image forming apparatus 100 in a one-to-one manner via a communication cable. Further, the finisher 300 is also connected with the image forming apparatus 100 in a one-to-one manner via a communication cable. Furthermore, the inspection apparatus 200 and the finisher 300 are also connected to each other via a communication cable.

### <Configuration of Image Forming Apparatus>

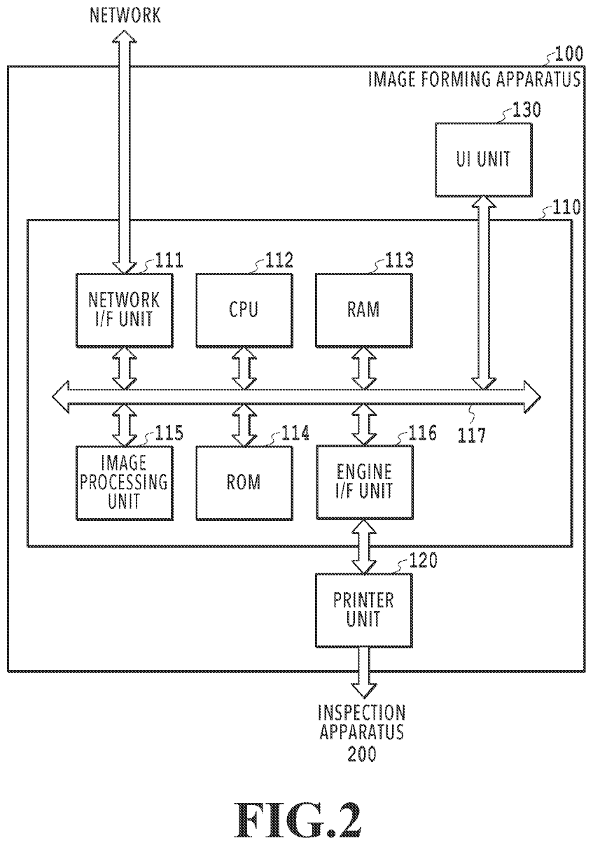

FIG. 2 is a diagram showing a hardware configuration example of the image forming apparatus 100 according to the present embodiment. The image forming apparatus 100 comprises a main controller 110, a printer unit 120, and a UI unit 130. A user inputs PDL data as input data to the image forming apparatus 100 from a software application, such as a printer driver or the like not shown schematically, on the client PCs 20/21 or the print server 30. The PDL data is print instructions data predefining arrangement of pictorial patterns or the like to be formed on a printed material, page order, page-imposition information and the like for each page. The main controller 110 receives PDL data from the client PCs 20/21 or the print server 30 and converts the PDL data into print data that can be processed in the printer unit 120 and outputs to the printer unit 120.

The printer unit 120 prints an image on a sheet based on the print data received from the main controller 110. Explanation is given by taking an example in which the printer unit 120 is a print engine adopting the electrophotographic method, but the printing method is not limited to the electrophotographic method and for example, the printing method may be the ink jet method.

The UI unit 130 is a user interface used by a user to select various functions and give various operation instructions. The UI unit 130 comprises a liquid crystal display on the surface of which a touch panel is provided, a keyboard on which various keys, such as a start key, a stop key, and a tenkey, are arranged, and the like.

The main controller 110 has a network I/F (interface) unit 111, a CPU 112, a RAM 113, a ROM 114, an image processing unit 115, an engine I/F unit 116, and an internal bus 117.

The network I/F unit 111 is an interface for receiving PDL data transmitted from the client PCs 20/21 or the print server 30. The CPU 112 performs processing, to be described later, which is performed by the main controller 110, as well as controlling the whole image forming apparatus 100 by using programs and data stored in the RAM 113 and the ROM 114. The RAM 113 provides a work area used by the CPU 112 in a case of performing various types of processing. The ROM 114 stores programs and data for causing the CPU 112 to perform various types processing, to be described later, setting data of the main controller 110, and the like.

The image processing unit 115 performs printing image processing for the PDL data received by the network I/F unit 111 in accordance with instructions from the CPU 112 and generates print data that the printer unit 120 can process. The image processing unit 115 generates image data in which one pixel has a plurality of color components by performing rasterization for the received PDL data. Here, the plurality of color components is color components independent in the color space, for example, such as RGB (red, green, blue). In the generated image data, one color component has an 8-bit value (256 tones) for each pixel. That is, the image data is multivalued bitmap data including multivalued pixels. Further, in rasterization, attribute data indicating the attribute of the pixel configuring the image data for each pixel is also generated. This attribute data indicates to which type of object each pixel belongs and is a value indicating the type of object, for example, such as character, line, graphic, image, and background. The image processing unit 115 generates print data that the printer unit 120 can process by performing color conversion from the RGB color space into the CMYK (cyan, magenta, yellow, black) color space, screen processing and the like by using the generated image data and attribute data. The engine I/F unit 116 is an interface transmitting the print data generated by the image processing unit 115 to the printer unit 120. The internal bus 117 is a system bus connecting each of the above-described units.

### <Internal Configuration of Printer Unit>

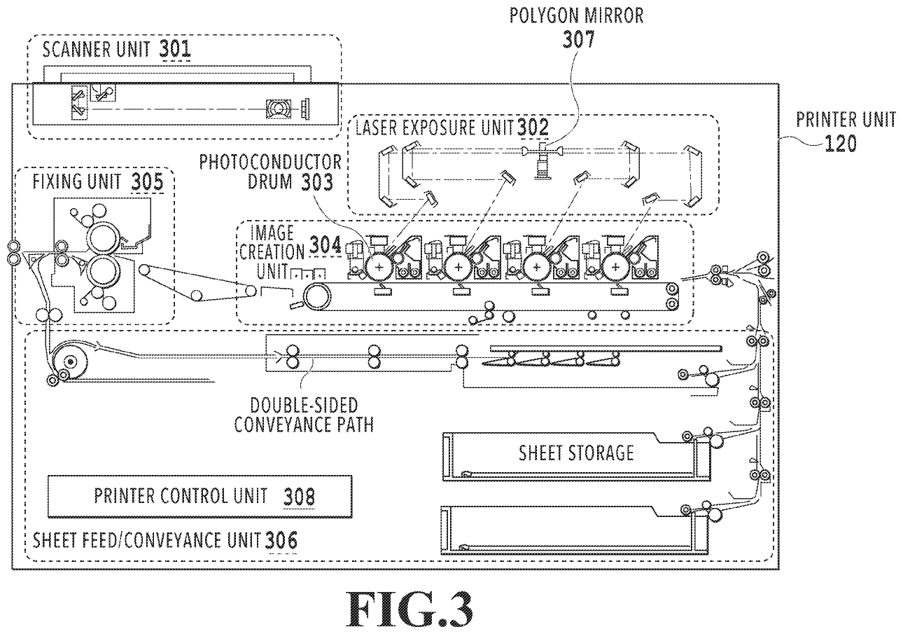

FIG. 3 is a diagram showing an internal configuration example of the printer unit 120 of the image forming apparatus 100. The printer unit 120 includes a scanner unit 301, a laser exposure unit 302, a photoconductor drum 303, an image creation unit 304, a fixing unit 305, a sheet feed/conveyance unit 306, and a printer control unit 308 configured to control these units.

The scanner unit 301 optically reads an image on a document placed on a document table by illuminating the image and creates image data by converting the read image into an electric signal. The laser exposure unit 302 causes a light beam, such as a laser beam modulated in accordance with print data, to enter a rotary polygon mirror rotating at uniform angular velocity and irradiates the photoconductor drum 303 with the light as reflected scanning light. The image creation unit 304 drives the photoconductor drum 303 rotatably and electrifies with a charger and develops the latent image formed on the photoconductor drum 303 by the laser exposure unit 302 with toner. The printer unit 120 implements print processing by having four developing units (development stations) performing a series of electrophotographic processes, such as transferring the toner image onto a sheet, collecting minute toner that remains on the photoconductor drum without being transferred at that time, and so on. The four developing units arranged in order of cyan (C), magenta (M), yellow (Y), and black (K) sequentially performs the operation to create magenta, yellow, and black images after a predetermined time elapses from the start of the image creation of the cyan station. The fixing unit 305 includes a combination of rollers and belts and incorporates a heating source such as a halogen heater and fuses and fixes the toner on the sheet onto which the toner image is transferred by the image creation unit 304 with heat and pressure. The sheet feed/conveyance unit 306 has one or more sheet storages, typically such as a sheet cassette and a paper deck, and separates one sheet from a plurality of sheets stored in the sheet storage in response to instructions of the printer control unit 308 and conveys the sheet to the image creation unit 304 and the fixing unit 305. Onto the conveyed sheet, a toner image of each color is transferred in the development station and finally a full-color toner image is formed on the sheet. Further, in a case where an image is formed on both sides of the sheet, the sheet having passed through the fixing unit 305 is controlled so as pass again through the conveyance path through which the sheet is conveyed to the image creation unit 304. The printer control unit 308 communicates with the main controller 110 controlling the image forming apparatus 100 and performs printing control in accordance with the instructions of the main controller 110. The printer control unit 308 gives instructions so that all the units can operate smoothly in harmony with one another while managing the state of each of the scanner, laser exposure, image creation, fixing, sheet feed/conveyance units.

### <Internal Configuration of Inspection Apparatus>

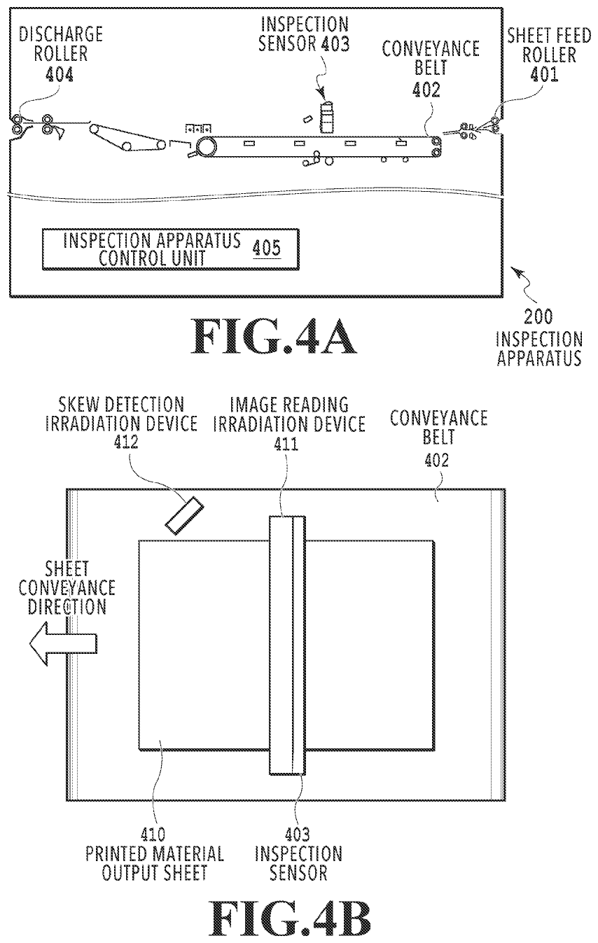

FIG. 4A is a diagram showing an internal configuration example of the inspection apparatus 200. The printed material, which is the sheet output from the main controller 110 and for which print processing has already been performed, is pulled into the inspection apparatus 200 by a sheet feed roller 401. After that, the printed material is read by an inspection sensor 403 as an image reading unit, which is located above a conveyance belt 402 while being conveyed by the conveyance belt 402. Then, an inspection apparatus control unit 405 performs inspection processing by using the image (scanned image) obtained by the reading of the inspection sensor 403. In the following, the inspection-target scanned image obtained by reading the printed material is called “inspection image”. Further, the inspection apparatus control unit 405 also controls the whole inspection apparatus 200. The inspection results are sent to the finisher 300. After inspection is performed, the printed material is output from a discharge roller 404. Although not shown schematically here, the inspection sensor 403 may have a structure capable of reading also from the lower side of the conveyance belt 402 in order to deal with a double-sided printed material.

FIG. 4B is a top diagram in a case where the portion of the conveyance belt 402 is viewed from above. In FIG. 4B, the inspection sensor 403 is shown as a line sensor reading the whole surface of a printed material 410 that is conveyed for each line. An image reading irradiation device 411 radiates light for reading an image (pictorial pattern) formed on the printed material 410 with the inspection sensor 403. A skew detection irradiation device 412 radiates light for reading whether the printed material is inclined with respect to the sheet conveyance direction in a case where the printed material is conveyed on the conveyance belt 402. The skew detection irradiation device 412 reads the image of the shadow at the end portion of the sheet by irradiating the sheet that is conveyed with light from an oblique direction and detects a skew. In the present embodiment, the configuration is such that the reading of the shadow image at the end portion of the sheet is performed by the inspection sensor 403, but the configuration may be one in which another reading sensor other than the inspection sensor 403 is used.

### <Internal Configuration of Inspection Apparatus Control Unit>

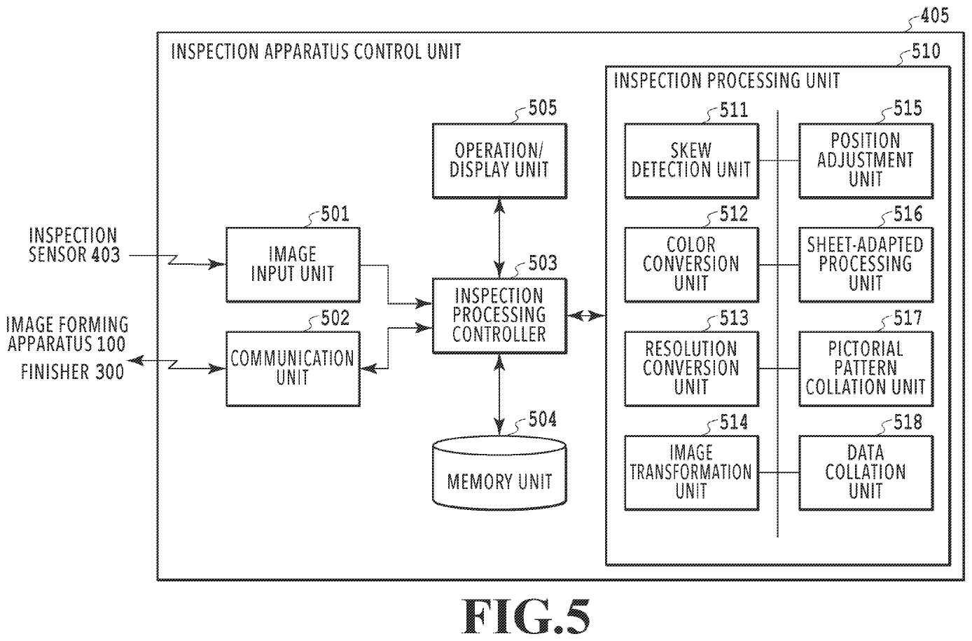

FIG. 5 is a diagram showing an internal configuration example of the inspection apparatus control unit 405. The whole inspection apparatus control unit 405 is controlled by an inspection processing controller 503. An image input unit 501 receives an inspection image read by the inspection sensor 403. The received inspection image is stored in a memory unit 504. Further, a communication unit 502 performs communication with the main controller 110 of the image forming apparatus 100. Specifically, the communication unit 502 performs reception of image data (reference image data taken as a reference of inspection) corresponding to the inspection-target printed material and utilized for the printing of the printed material, reception of information (sheet information) relating to the sheet utilized for the printing, transmission and reception of inspection control information, and so on. The received reference image data, sheet information, and inspection control information are stored in the memory unit 504. As the inspection control information that is transmitted to and received from the image forming apparatus 100, there are synchronization information for establishing a correspondence between the inspection image and the reference image with respect to the print job, number of copies to be printed, the page order and the like, inspection results information, and printing control information controlling the operation of the image forming apparatus 100 accompanying thereto. The synchronization information is necessary in a case where the order the inspection apparatus 200 receives the inspection image and the reference image utilized for printing the inspection image is different because of double-sided printing and printing of a plurality of copies. Further, the synchronization information is also necessary in a case where one reference image corresponds to a plurality of inspection images. As the inspection control information that is transmitted to and received from the finisher 300, there are inspection results information and finisher control information controlling the operation of the finisher 300 accompanying thereto. An operation/display unit 505 is a user interface, which is, for example, a touch screen. The operation/display unit 505 displays various user interface screens (UI screens), to be described later, under the display control by the inspection processing controller 503. The various UI screens are configured so as to be capable of receiving various user operations, such as designation of a setting value or the like in target processing and instructions to perform specific processing.

An inspection processing unit 510 is controlled by the inspection processing controller 503. The inspection processing unit 510 sequentially inspects a pair of an inspection image and a reference image, which are in a correspondence relationship, based on synchronization information, which is one piece of inspection control information transmitted to and received form the image forming apparatus 100. Details of the inspection performed by the inspection processing unit 510 will be described later, After the inspection is completed, the results thereof are displayed on the operation/display unit 505. In a case where some defect is detected by the inspection, in accordance with the contents of the defect, the operation of the image forming apparatus 100 and the finisher 300 is controlled via the communication unit 502. For example, in a case where an image defect is detected, control is performed to stop the print processing in the image forming apparatus 100, switch the discharge destination of a printed sheet from a stack tray to an escape tray in the finisher 300, and so on.

### <<Internal Configuration of Inspection Processing Unit>>

Next, the internal configuration of the inspection processing unit 510 is explained. As shown in FIG. 5, the inspection processing unit 510 has a skew detection unit 511, a color conversion unit 512, a resolution conversion unit 513, an image transformation unit 514, a position adjustment unit 515, a sheet-adapted processing unit 516, a pictorial pattern collation unit 517, and a data collation unit 518. In the following, each unit is explained.

The skew detection unit 511 is a module detecting a skew angle of an inspection image. The inspection image is scanned so that a shadow is formed at the end portion of a sheet. The reason is that the inspection sensor 403 scans the shadow at the end portion of the sheet, which is formed in a case where the sheet pulled into the inspection apparatus 200 and conveyed on the conveyance belt 402 is irradiated with light by the skew detection irradiation device 412. The skew detection unit 511 detects a skew angle by using this shadow at the end portion of the sheet. The skew angle detected here is utilized by the image transformation unit 514 for correction processing, to be described later.

The color conversion unit 512 is a module performing intermediate color conversion for a reference image. Normally, while the color of each pixel of the reference image is predefined in the CMYK color space, the color of each pixel of the inspection image is predefined in the RGB color space. Because of this, it is necessary to perform color conversion from the CMYK color space into the RGB color space, but the RGB values read by the inspection sensor 403 change largely depending on the sheet type. The color conversion unit 512 performs conversion into the RGB values (common RGB values) common to a plurality of sheet types. The converted reference image is converted into RGB values in accordance with each sheet type in the sheet-adapted processing unit 516, to be described later. The reference image data converted into common RGB values is data, for example, in which each pixel has a value representing each signal of RGB corresponding to sRGB in the RGB color space independent of the printer engine 111 by 256 tones. Here, sRGB refers to the standard of the RGB color space determined by IEC (International Electrotechnical Commission). The color conversion unit 512 converts the CMYK values of the reference image into common RGB values by using a lookup table of CMYKtoRGB, for example, such as Table 1 described below. In this case, for the pixel not located on the grid point predefined by the lookup table, corresponding RGB values are found by interpolation operation using the RGB values of adjacent pixels located on the grid points.

TABLE 1
CMYKtoRGB lookup table

| C | M | Y | K | R | G | B |
|---|---|---|---|---|---|---|
| 0 | 0 | 0 | 0 | 255 | 255 | 255 |
| 31 | 0 | 0 | 0 | 230 | 240 | 255 |
| 63 | 0 | 0 | 0 | 200 | 220 | 255 |
| 255 | 255 | 255 | 255 | 0 | 0 | 0 |

The resolution conversion unit 513 is a module converting the resolution of an inspection image and a reference image. There is a case where the resolution of the inspection image and the resolution of the reference image input to the inspection apparatus control unit 405 are different. Further, there is a case where the resolution utilized in each module of the inspection processing unit 510 and the resolution of the input inspection image and/or the reference image are different. In the case such as that, resolution conversion is performed in the resolution conversion unit 513. For example, it is assumed that the resolution of the inspection image in the main scanning direction is 600 DPI and that in the sub scanning direction is 300 DPI, the resolution of the reference image in the main scanning direction is 1,200 DPI and that in the sub scanning direction is 1,200 DPI, and the resolution that is necessary in the inspection processing unit 510 is 300 DPI both in the main scanning direction and in the sub scanning direction. In this case, each of the inspection image and the reference image is reduced and both images are turned into images whose resolution is 300 DPI both in the main scanning direction and in the sub scanning direction. As a reduction method, it may be possible to utilize a publicly known method by taking into consideration the calculation load and the required accuracy.

The image transformation unit 514 is a module performing transformation for the inspection image and the reference image. Between the inspection image and the reference image, a geometrical difference exists due to the expansion and contraction and skew of paper at the time of printing and the skew at the time of scan. The image transformation unit 514 corrects the geometrical difference by performing image transformation based on the information obtained by the skew detection unit 511 and the position adjustment unit 515. For example, the geometrical difference is linear transformation (rotation, enlargement/reduction, shearing) and translation. This geometrical difference can be represented as affine transformation and it is made possible to perform correction by obtaining affine transformation parameters from the skew detection unit 511 and the position adjustment unit 515. The information obtained from the skew detection unit 511 is only the parameters (skew angle information) relating to rotation.

The position adjustment unit 515 is a module performing position adjustment between the inspection image and the reference image. The premise is that the inspection image and the reference image have become images having the same resolution at the point in time at which they are input to the position adjustment unit 515. The higher the input resolution, the more the accuracy of position adjustment improves, but the heavier the calculation load becomes. By performing correction in the image transformation unit 514 based on the parameters obtained by position adjustment, it is made possible to obtain the inspection image and the reference image utilized in the pictorial pattern collation unit 517, to be described later. As the position adjustment method, a variety of position adjustment methods are considered but by performing position adjustment of the whole surface of the image by utilizing information on a partial area of the image in place of the whole surface of the image, it is possible to lighten the calculation load.

The sheet-adapted processing unit 516 is a module performing processing in accordance with the sheet used for printing for the reference image. Specifically, based on the inspection control information stored in advance in the memory unit 504 and the sheet information transmitted from the main controller 110, processing is performed, such as color conversion in accordance with the sheet type and rotation in accordance with the orientation of the sheet. As regards the color conversion, for the reference image converted into the RGB color space common to the sheet in the color conversion unit 512, conversion is performed by taking the RGB values read by the inspection sensor 403 for each sheet type as a target. This conversion is performed by using, for example, a lookup table of RGBtoRGB as Table 2 described below. It may also be possible to have a plurality of lookup tables and switch lookup tables in accordance with the sheet type.

TABLE 2
RGBtoRGB lookup table

| R | G | B | R | G | B |
|---|---|---|---|---|---|
| 255 | 255 | 255 | 220 | 220 | 220 |
| 230 | 240 | 255 | 200 | 215 | 220 |
| 200 | 220 | 255 | 170 | 210 | 220 |
| . | | | | | |
| . | | | | | |
| . | | | | | |
| 0 | | 0 | 3 | 3 | 3 |

The pictorial pattern collation unit 517 is a module determining quality of the pictorial pattern formed on the sheet by comparing the pictorial pattern in the inspection image and the pictorial pattern in the reference image processed in the sheet-adapted processing unit 516.

The data collation unit 518 is a module detecting a defect of specific data by extracting the specific data from the inspection image and collating the extracted specific data with correct data corresponding to the specific data set in advance. Specifically, whether the printed character string is correct or incorrect is determined by performing character recognition processing (OCR processing) for the character string area included in the inspection image to extract the character string and collating the extracted character string with the corresponding correct data. Alternatively, whether the printed barcode is correct or incorrect is determined by performing barcode recognition processing for the barcode area included in the inspection image to read the barcode and collating the read barcode with the corresponding correct data.

### <Operation of Inspection Apparatus>

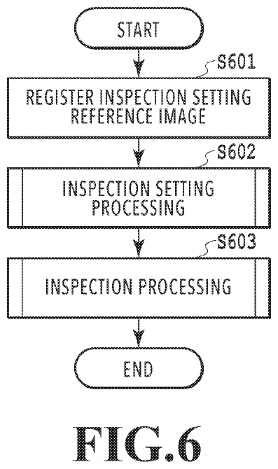

Following the above, the operation in the inspection apparatus 200 is explained. FIG. 6 is a flowchart showing a rough flow of the operation in the inspection apparatus 200. The series of processing shown in the flowchart in FIG. 6 is performed comprehensively by the inspection processing controller 503 based on a program stored in the memory unit 504. Further, the results of the processing at each step are stored appropriately in the memory unit 504 and utilized.

At S601, the registration of the reference image for inspection setting is performed based on user instructions. Specifically, the inspection apparatus 200 is brought into the state where it is possible for the inspection apparatus 200 to start reading of the printed material for registering the reference image and the print job for the registration of the reference image is input from the client PCs 20/21 and the print job is performed in the image forming apparatus 100.

At S602, processing (inspection setting processing) to set various inspection parameters, the target area (inspection area) within the inspection image, the inspection level and the like is performed. Details of the inspection setting processing will be described later.

At S603, the inspection processing is performed in accordance with the contents of the inspection setting, which are the results of the inspection setting processing at S602. Specifically, prior to the start of the inspection processing, the print job for inspection is input from the client PCs 20/21 and the print job is performed in the image forming apparatus 100. Then, in the inspection apparatus 200, the inspection image is obtained by scanning a printed sheet (printed material) that is conveyed from the image forming apparatus 100 and the inspection image is compared with the reference image and the inspection results are output. Details of the inspection processing will be described later.

The above is the rough flow of the operation in the inspection apparatus 200.

### <Details of Inspection Setting Processing>

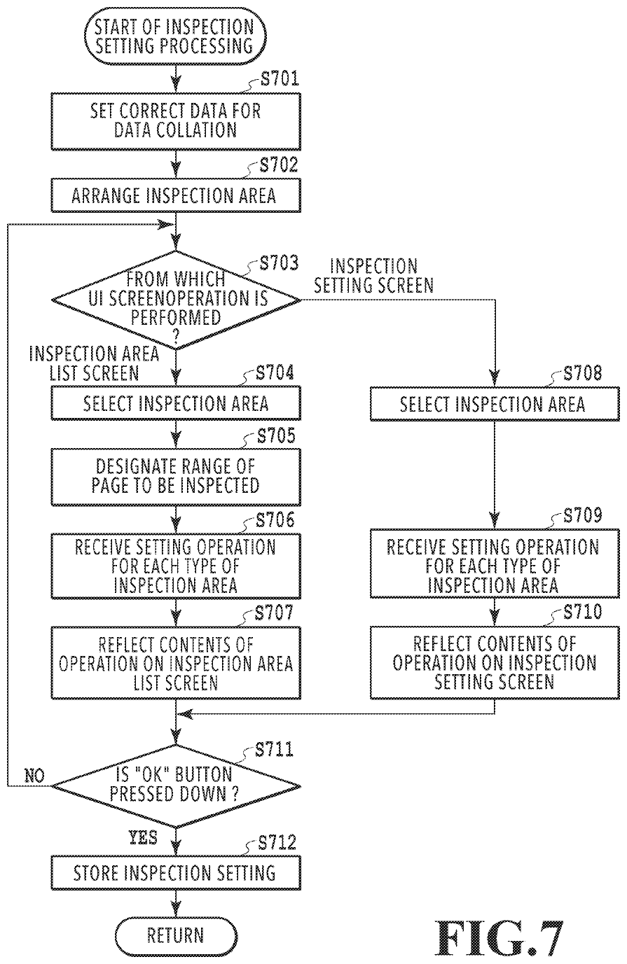

Next, details of the inspection setting processing (S602) are explained with reference to the flowchart in FIG. 7. This inspection setting processing is performed based on the user operation via the UI screen for inspection setting (inspection setting screen). The inspection setting screen is displayed by taking the reference image registered at S601 being selected on the operation/display unit 505 by a user as a trigger. Before the flowchart in FIG. 7 is explained, the inspection setting screen is explained.

### <<Explanation of Inspection Setting Screen>>

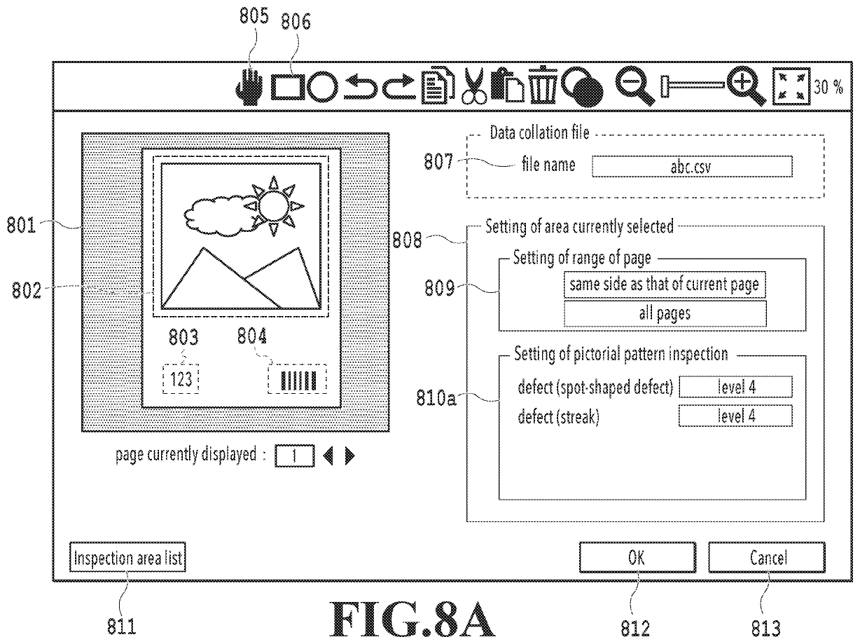

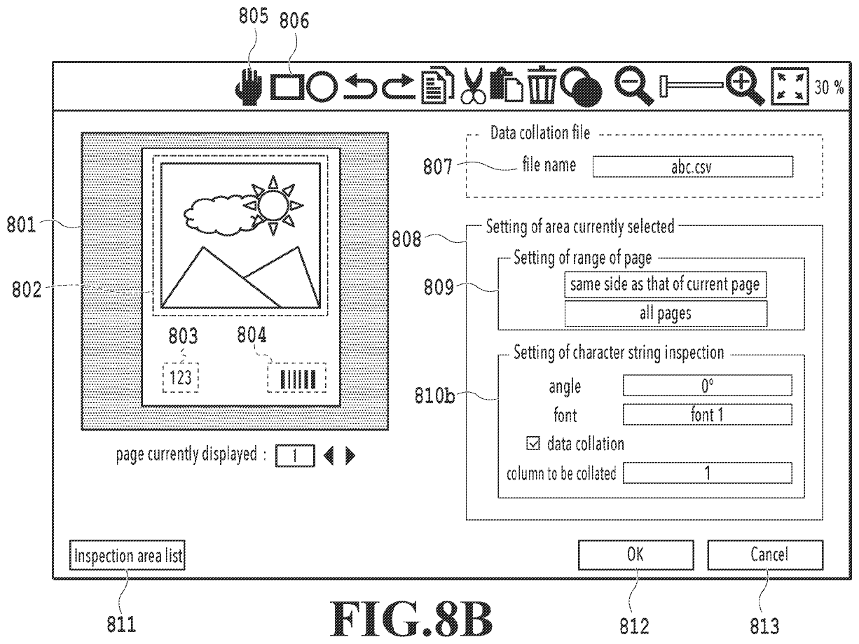

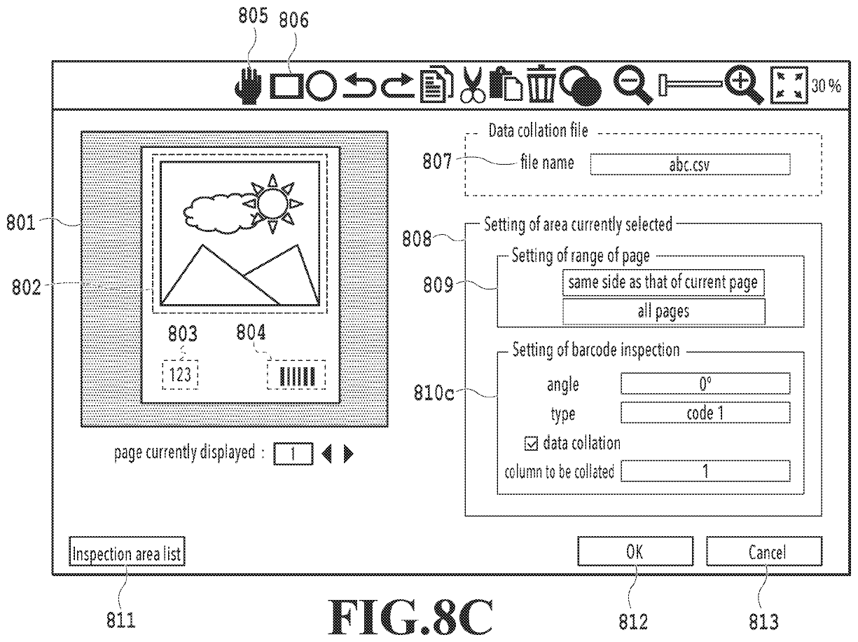

Here, FIG. 8A to FIG. 8C are each a diagram showing one example of the inspection setting screen. On the inspection setting screen in each of FIG. 8A to FIG. 8C, in a preview pane 801, the reference image for inspection setting relating to user selection is preview-displayed. In a case where the print job includes a plurality of pages, it is possible to switch reference images for inspection setting to be preview-displayed for each page by a page switch button located below the preview pane 801. Broken-line frames 802 to 804 within the preview pane 801 indicate the inspection areas arranged on the reference image for inspection setting currently preview-displayed. An inspection area selection button 805 is a button for selecting an arbitrary inspection area from among the arranged inspection areas. Here, the inspection area 802 indicates a pictorial pattern inspection area, the inspection area 803 indicates a character string inspection area, and the inspection area 804 indicates a barcode inspection area. A user arranges inspection areas by selecting the type of inspection area from a pulldown menu to be displayed after an inspection area arrangement button 806 is pressed down and selecting the area the user desires to designate as the inspection area on the preview display thereafter by the drag operation.

A data setting pane 807 is a pane for selecting correct data for data collation processing by a file selection method. The data collation processing is processing to check whether the character string or the barcode on a printed material is correct or incorrect by reading them and the correct data (reference CSV file) used at that time is set in the data setting pane 807. The reference CSV file is a file that should be prepared in advance on the user side and is a file in which correct character strings in the character string inspection, or character strings that should have been encoded by barcodes in the barcode inspection are enumerated.

An inspection condition setting pane 808 is a pane for designating an individual setting value for the inspection area currently selected. Within the inspection condition setting pane 808, two kinds of setting item 809 and 810 exist. In the setting item 809, the range of the page for which inspection is performed by the inspection area currently selected is designated. In a case where “same side as that of current page” is selected, in accordance with on which of the obverse side and the reverse side the inspection area currently selected is arranged, the inspection area currently selected is arranged for the page of the same side. In a case where “all pages” is selected, the inspection area currently selected is arranged for all the pages. In the setting item 810, the contents in accordance with the type of the inspection area are designated.

A setting item 810a on the inspection setting screen in FIG. 8A shows the state in a case where the pictorial pattern inspection area 802 is selected. In the setting item 810a in a case where the pictorial pattern inspection area 802 is selected, which kind of defect is inspected and how minute a defect is detected (inspection level) are designated. Here, as the kinds of defect, for example, there are a circular defect (spot-shaped defect), a linear defect (streak) and the like. Further, as the inspection levels, for example, there are five levels from “level 1” to “level 5” and at “level 5”, it is possible to detect a thinner and smaller-sized defect than “level 1”. The inspection level can be set for each kind of defect and for example, it is also possible to designate that the spot-shaped defect is detected at “level 5” and the streak is detected at “level 4”.

A setting item 810b on the inspection setting screen in FIG. 8B shows the state in a case where the character string inspection area 803 is selected. In the setting item 810b in a case where the character string inspection area 803 is selected, the angle of the inspection area in a case where inspection is performed, the font of the character string, whether to perform data collation processing, which column of the reference CSV file is referred to in a case where data collation processing is performed are designated.

A setting item 810c on the inspection setting screen in FIG. 8C shows the state in a case where the barcode inspection area 804 is selected. In the setting item 810c in a case where the barcode inspection area 804 is selected, the angle of the inspection area in a case where inspection is performed, the kind of barcode, whether to perform data collation processing, which column of the reference CSV file is referred to in a case where data collation processing is performed are designated. In the present embodiment, by displaying the setting item in accordance with the type of the selected inspection area, irrelevant items are prevented from being displayed, but this is not limited. For example, it may also be possible to display all the items and invalidate irrelevant items, or it may also be possible to fold irrelevant items so that they are not displayed.

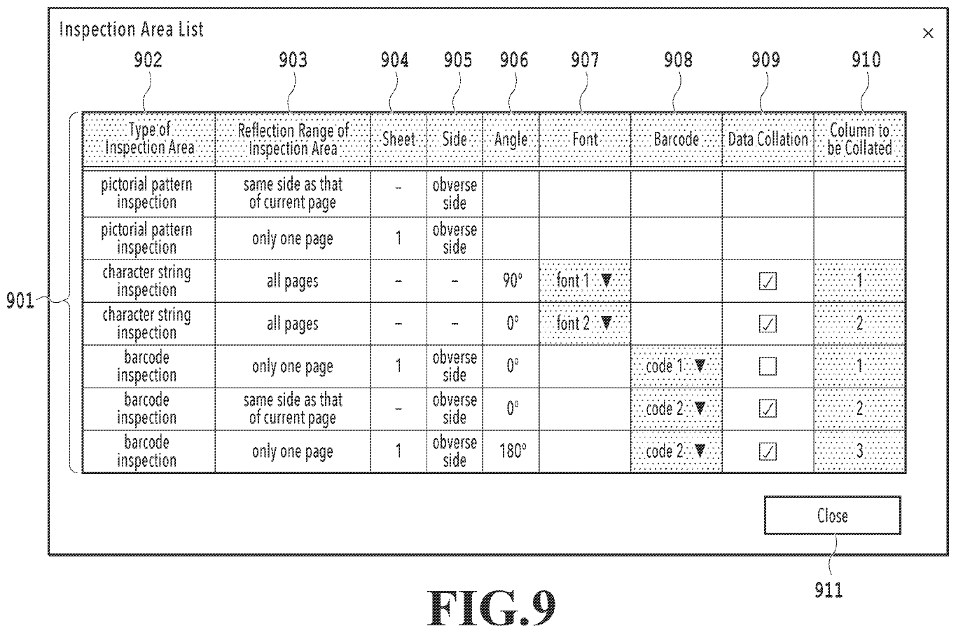

An “Inspection area list” button 811 is a button for displaying a list of the inspection areas currently set. In a case where a user presses down the “Inspection area list” button 811, a UI screen (inspection area list screen) showing a list of inspection areas as shown in FIG. 9, to be described later, is displayed. An “OK” button 812 is a button for completing the inspection setting. In a case where a user presses down the “OK” button 812, the inspection setting is completed with the contents designated up to that point in time and the inspection setting with the designated contents is stored in the memory unit 504. It may also be possible to invalidate the “OK” button 812 so that a user can no longer press down the “OK” button in a case where the contents designated by the user are inconsistent. As an example of inconsistent contents, there is a case where the inspection area for which data collation processing is performed exists, but the reference CSV file for collation is not designated in the data setting pane 807, or the like. A “Cancel” button 813 is a button for cancelling the work of the inspection setting. In a case where a user presses down the “Cancel” button 813, the designated contents on which the user is currently working are disposed of and the inspection setting processing is terminated.

### <<Inspection Area List Screen>>

FIG. 9 is one example of the inspection area list screen displaying a list of inspection areas currently set and capable of receiving an operation to change inspection setting from a user. Each row in the list corresponds to each arranged inspection area. It is possible for a user to check and change the setting value by selecting the inspection area one by one on the inspection setting screen described above, but it takes many operations and much time to check and change the setting of a plurality of inspection areas in order. On the inspection area list screen in FIG. 9, it is possible to check and change the setting values of the plurality of inspection areas en bloc. This inspection area list screen is displayed in, for example, another floating window different from that of the inspection area list screen. Alternatively, it may also be possible to display the inspection area list screen by causing the inspection setting screen to make a transition.

On the inspection area list screen shown in FIG. 9, a user selects the setting value shown in a display row 901 corresponding to each inspection area by a click or tap. For example, it may also be possible to receive the duplication and deletion of a selected inspection area by opening a context menu by the operation, for example, such as a right-click. Each individual display row includes each item of “Type of Inspection Area” 902, “Reflection Range of Inspection Area” 903, “Sheet” 904, “Side” 905, “Angle” 906, “Font” 907, “Barcode” 908, “Data Collation” 909, and “Column to be Collated” 910.

In the “Type of Inspection Area” 902, which type of inspection is performed for the inspection area is shown. In the “Reflection Range of Inspection Area” 903, the range of the page in which the inspection area is the target is shown. In the “Sheet” 904, the sheet on which the inspection area is arranged is shown. In the “Side” 905, whether the side on which the inspection area is arranged is the obverse side or the reverse side is shown. In the “Angle” 906, the angle of the inspection area is shown. In the “Font” 907, the font of a character included in the inspection area is shown. It is possible for a user to change the type of font by a pulldown menu. In the “Barcode” 908, the type of barcode included in the inspection area is shown. It is possible for a user to change the type of barcode by a pulldown menu. In the “Data Collation” 909, whether to perform data collation processing for the inspection area is shown. It is possible for a user to change whether to perform data collation processing by a checkbox. In the “Column to be Collated” 910, with which column of the reference CSV file collation is performed in a case where data collation processing is performed for the inspection area is shown. It is possible for a user to change the value by directly inputting the value. A “Close” button 911 is a button for terminating the display of the inspection area list screen.

By using the inspection setting screen and the inspection area list screen as above, the inspection setting processing is performed. In the following, explanation is given along the flowchart in FIG. 7. In the following explanation, a symbol “S” means a step.

At S701, based on the user operation, correct data for data collation processing is set. At S702, based on the user operation, the inspection area is arranged. At S703, the next processing is allocated depending on whether the detected user operation is performed from the inspection setting screen or the inspection area list screen. In a case where the user operation is from the inspection setting screen, the processing at S704 to S707 is performed. On the other hand, in a case where the user operation is from the inspection area list screen, the processing at S708 to S710 is performed.

At S704, an inspection area is selected via the inspection setting screen. At S705, the range of a page is designated via the inspection setting screen. At S706, the setting in accordance with the type of inspection area is performed via the inspection setting screen. At S707, the contents of the user operation performed on the inspection setting screen are reflected (the display contents are synchronized) on the inspection area list screen.

At S708, an inspection area is selected via the inspection area list screen. At S709, the setting in accordance with the type of inspection area is performed via the inspection area list screen. At S710, the contents of the user operation performed on the inspection area list screen are reflected (the display contents are synchronized) on the inspection setting screen.

At S711, whether the inspection setting is completed, specifically, whether the pressing down of the “OK” button 812 on the inspection setting screen is detected is determined. In a case where the inspection setting is completed, the processing advances to S712. In a case where the inspection setting is not completed, the processing returns to S703.

At S712, the contents of the current inspection setting screen are stored in the memory unit 504 as the inspection setting and the inspection setting processing is terminated.

The above is the contents of the inspection setting processing.

### <Details of Inspection Processing>

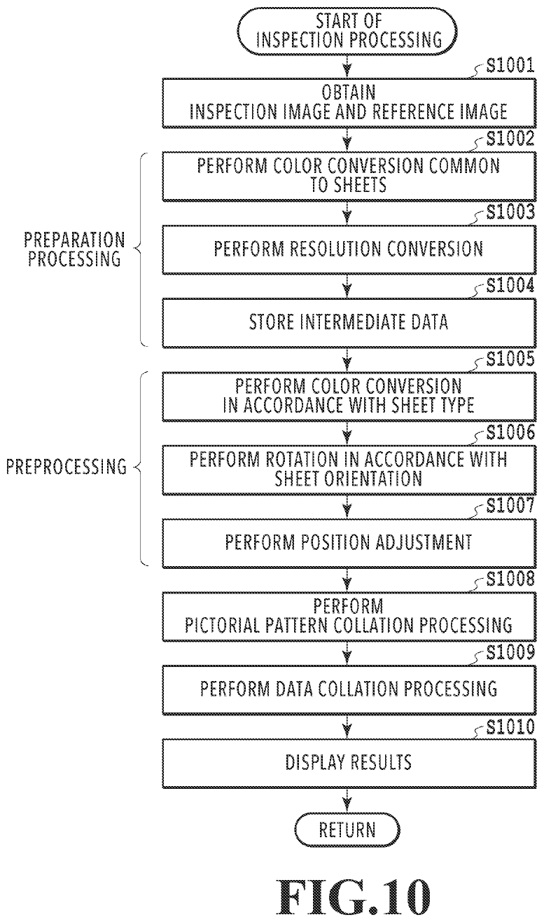

Following the above, details of the inspection processing (S603) performed in accordance with the inspection setting by the above-described inspection setting processing according to the present embodiment are explained with reference to the flowchart in FIG. 10. In the following explanation, a symbol “S” means a step.

At S1001, the data of the inspection image obtained by scanning a printed material and the image (reference image) used for the printing of the inspection image is obtained from the image forming apparatus 100 via the communication unit 502. The obtained data is stored in the memory unit 504.

Next S1002 to S1004 are preparation processing not depending on the sheet type. From the memory unit 504, the reference image is read and first, at S1002, color conversion into the color space common to sheets by the color conversion unit 512 is performed. Then, at S1003, conversion into the resolution required by the inspection processing unit 510 is performed by the resolution conversion unit 513. The data of the reference image for which color conversion and resolution conversion have been performed is stored in the memory unit 504 in association with the ID included in the inspection control information. By this preparation processing, for example, a CMYK image whose resolution in the main scanning is 1,200 DPI and whose resolution in the sub scanning is 1,200 DPI is converted into, for example, an RGB image whose resolution both in the main scanning and in the sub scanning is 300 DPI. In this example, the resolution is reduced to 1/16 and the number of channels is reduced by one.

Next S1005 to S1007 are preprocessing to modify the reference image in order to enable the comparison with the inspection image. First, at S1005, color conversion by the sheet-adapted processing unit 516 is performed, which is in accordance with the type of sheet used for printing. Further, processing to rotate the reference image in accordance with the orientation of the sheet (orientation of the inspection image) by the sheet-adapted processing unit 516 is performed. Then, at S1007, the position adjustment between the inspection image and the reference image by the position adjustment unit 515 is performed.

At S1008, the pictorial pattern collation unit 517 performs pictorial pattern collation processing to determine whether or not an image defect exists based on the setting contents (see FIG. 8A) relating to the pictorial pattern inspection by using the inspection image and the reference image obtained at S1007. The determination results are stored in the memory unit 504.

Then, in a case where the setting to perform data collation is performed in the inspection setting, at S1009, the data collation unit 518 performs data collation processing to determine whether the character string and/or the barcode included in the inspection image obtained at S1007 is correct or incorrect by reading them. Specifically, first, based on the setting contents (see FIG. 8B and FIG. 8C) relating to the data inspection, for the character string inspection area 803/the barcode inspection area 804 within the inspection image, character string recognition processing/barcode recognition processing are performed. Then, the collation between the obtained recognition results and the correct character string corresponding to the target inspection area is performed with reference to the reference CSV file. The determination results are stored in the memory unit 504.

Then, at S1010, the results of the pictorial pattern collation processing at $1008 and the results of the data collation processing at S1009, both stored in the memory unit 504, are displayed on the operation/display unit 505 as inspection results.

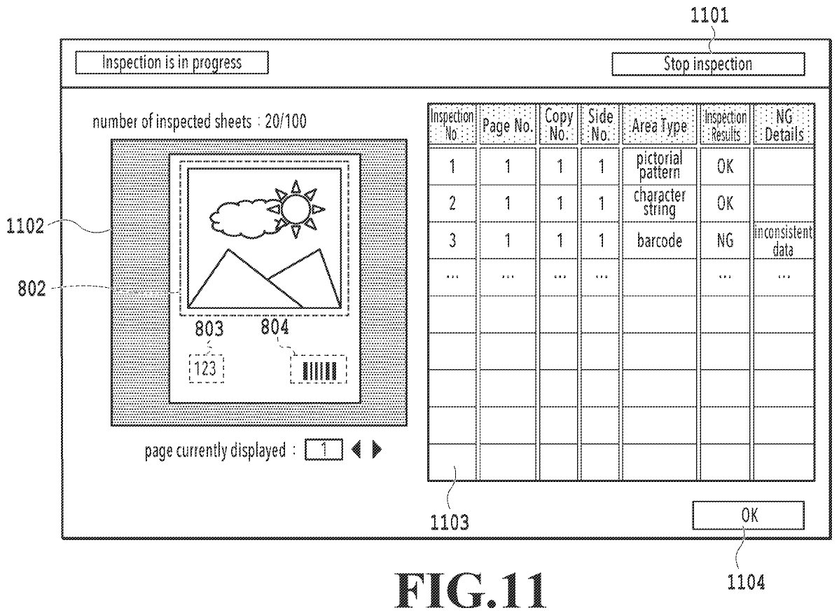

The above is the flow of the inspection processing. FIG. 11 is a diagram showing one example of a UI screen (inspection results display screen) displaying the inspection results at S1010. On the inspection results display screen shown in FIG. 11, a button 1101 is a button for stopping inspection and in a case where the button 1101 is pressed down, processing to stop the inspection print job currently performed is performed. In a preview pane 1102, an inspection image is displayed. In a results display pane 1103, a list of the results of the collation processing in accordance with the inspection setting is displayed for each inspection area. Information for uniquely identifying the inspection area, for example, “Inspection No.” indicating which inspection area in the page, “Page No.” indicating what number page, “Copy No.” indicating what number copy, and “Side No.” indicating the obverse side or the reverse side are displayed. Further, “Area Type” indicating whether the target of the pictorial pattern collation processing or the target of the data collation processing (character string or barcode), “Inspection Results” indicating the results of the collation processing of the target, and “NG Details” indicating the detailed cause in a case where the inspection results are NG are displayed. Here, in the example in FIG. 11, the inspection results for each inspection area whose type is “pictorial pattern inspection”, “character string inspection”, and “barcode inspection” are displayed, respectively. Then, it is indicated that the inspection results of the barcode inspection area 804 corresponding to Inspection No. 3 are NG because of the inconsistency between the correct data described in the reference CSV and the barcode recognition results. A button 1104 is a button for terminating the inspection processing and in a case where the button 1104 is pressed down, the inspection results at that point in time are stored in the memory unit 504 and the inspection processing is terminated.

### Modification Example

As a simpler modification example of the embodiment described above, it is also possible to detect only a data defect in PDL data creation processing (prepress processing). For example, it may also be possible to perform the data collation processing (S1009) in the flow in FIG. 10 described previously for the print data generated by an image processing apparatus specialized in the function of the image processing unit 115 of the image forming apparatus 100 and adapted to the printer engine of another apparatus. Due to this, it is possible to mount part of the functions of the inspection apparatus of the present disclosure also in an apparatus not having a printer engine, for example, such as the client PCs 20/21 and a processing apparatus on the cloud, not shown schematically.

As above, according to the present embodiment, wide defect inspection is enabled, which deals also with a case where there is no problem in the print processing based on input PDL data but there is a problem in the PDL data creation processing (prepress processing).

### Second Embodiment

Next, an aspect in which recovery control is added to the configuration of the first embodiment is explained as a second embodiment. Explanation of the contents common to those of the first embodiment is omitted and in the following, different points are explained.

### <Details of Inspection Processing>

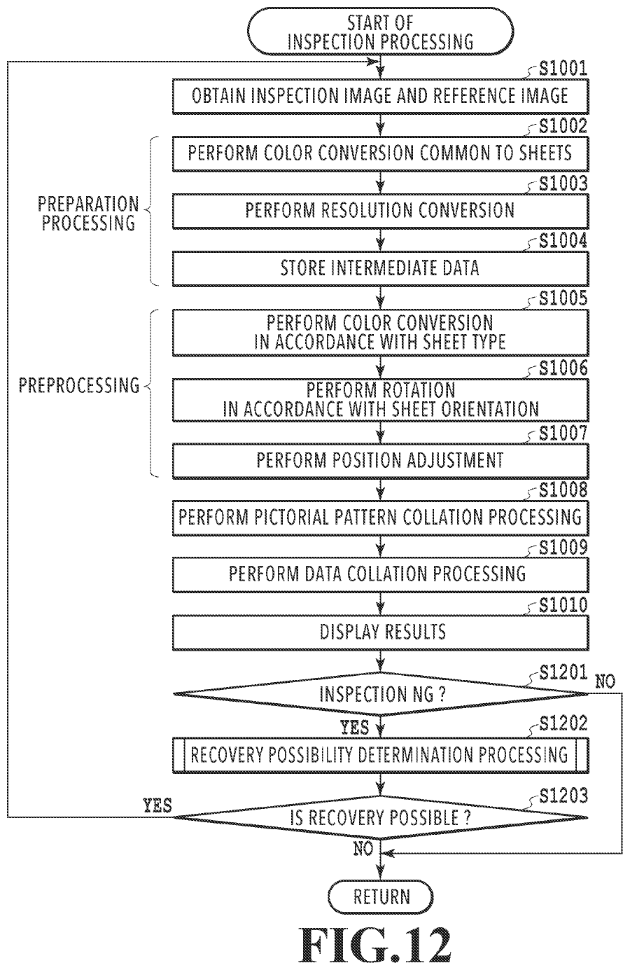

Details of the inspection processing (S603) according to the present embodiment are explained with reference to the flowchart in FIG. 12. In the following explanation, a symbol “S” means a step. Further, S1001 to S1010 are the same as those in the flow in FIG. 10 of the first embodiment, and therefore, explanation is omitted.

At S1201 that follows S1010, whether or not NG is included in the results of the preceding pictorial pattern collation processing and data collation processing. In a case where the determination results indicate that NG is included, the processing advances to S1202. On the other hand, in a case where NG is not included, it is possible to determine that the recovery processing is not necessary (inspection OK) at this point in time, and therefore, this flow is terminated immediately.

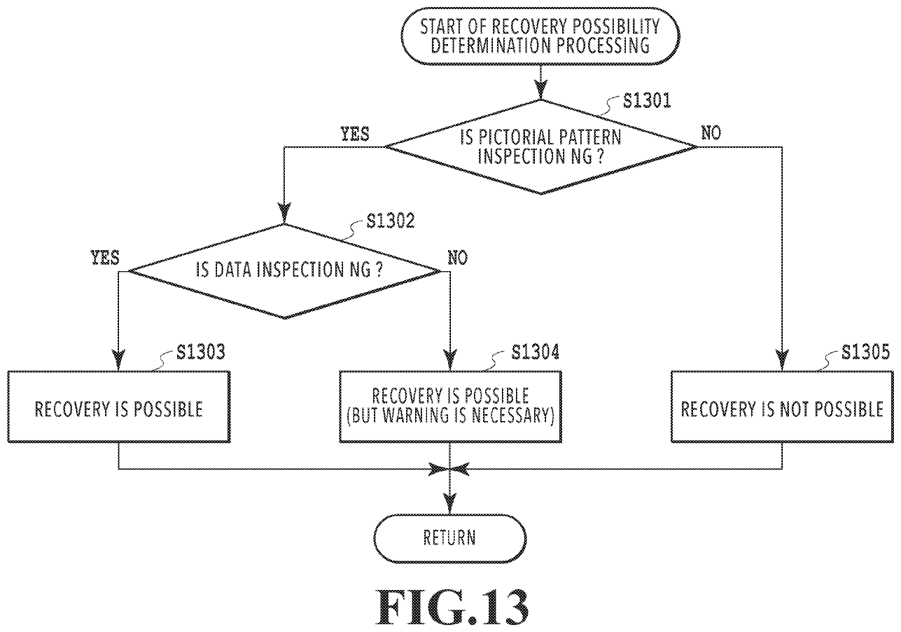

At S1202, processing to determine whether or not recovery processing is possible (recovery possibility determination processing) for the inspection NG is performed, which is the determination results at S1201. Here, “recovery processing” means causing the image forming apparatus 100 to perform print processing reusing the PDL data, that is, to perform printing in accordance with the same inspection print job and the inspection processing thereof again. Then, “recovery processing is possible” means that there is a possibility to a certain extent that the output printed material becomes “inspection OK” in reinspection by the recovery processing. Details of the recovery possibility determination processing will be described later by using the flowchart in FIG. 13.

At S1203, in accordance with the results of the recovery possibility determination processing at S1202, the next processing is allocated. In a case where the determination results indicate that recovery is possible, the processing returns to S1001 and the same processing is repeated. In this case, instructions to reperform the print processing based on the PDL data of the printed material determined to be “NG” are given separately from the inspection processing controller 503 to the image forming apparatus 100.

On the other hand, in a case where the determination results indicate that recovery is not possible, it is determined that the recovery processing is not performed and this flow is terminated. In this case, instructions to stop the execution of the print job currently processed are given from the inspection processing controller 503 to the image forming apparatus 100. Further, instructions to perform purge control (control to switch the discharge destination to the escape tray and discharge the printed sheet of the page determined to be “NG” onto the escape tray) are given from the inspection processing controller 503 to the finisher 300.

The above is the contents of the inspection processing according to the present embodiment.

### <Details of Recovery Possibility Determination Processing>

Following the above, with reference to the flowchart in FIG. 13, details of the recovery possibility determination processing are explained. In the following explanation, a symbol “S” means a step.

At S1301, depending on whether or not NG is included in the results of the preceding pictorial pattern collation processing (S1008), the next processing is allocated. In order to determine whether or not NG is included in the results of the pictorial pattern processing, it may be possible to refer to the results of the determination of whether or not a defect exists, which are stored in the memory unit 504 as S1008. Alternatively, it may also be possible to refer to “Inspection Results” whose “Area Type” on the inspection results display screen (see FIG. 11) displayed at S1010 is “pictorial pattern”. In a case where inspection NG is included in the results of the pictorial pattern collation processing, the processing advances to S1302 and in a case where inspection NG is not included, the processing advances to S1305.

At S1302, depending on whether or not inspection NG is included in the results of the preceding data collation processing (S1009), the next processing is further allocated. In order to determine whether NG is included in the results of the data collation processing, it may also be possible to refer to the results of the determination of whether or not a defect exists, which are stored in the memory unit 504 at S1009, or it may also be possible to refer to “Inspection Results” whose “Area Type” on the inspection results display screen (see FIG. 11) displayed at S1010 is “character string” or “barcode”. In a case where NG is included in the results of the data collation processing, the processing advances to S1303 and in a case where NG is not included, the processing advances to S1304

At S1303, it is determined that recovery is possible. For the printed material in a case where the results are NG both in the pictorial pattern inspection and in the data inspection, it is possible to estimate that NG results from the occurrence of a defect (image defect), such as soiling or a thin spot, at the time of print processing and that there is no defect in the PDL data itself included in the inspection print job. In a case of soiling resulting from the scattering of toner or the like, there is a possibility that this does not occur in the next print processing, and therefore, by performing printing again by using the same PDL data, there is a possibility that the results become OK both in the pictorial pattern inspection and in the data inspection, and therefore, it is determined that recovery is possible.

At S1304, it is determined that recovery is possible. However, in this case, there is a possibility that an image defect, such as soiling and a thin spot, occurs also in a printed material obtained by the print processing for the second time, and therefore, the inspection processing controller 503 gives a warning to a user by causing the operation/display unit 505 to display a warning message or the like.

At S1305, it is determined that recovery is not possible. For the printed material in a case where the results of the pictorial pattern inspection are OK but the results of the data inspection are NG, it is considered that there is no problem in the print processing itself. That is, it is possible to estimate that inspection NG results from a defect in the data itself, which is caused by, for example, the allocation of pages in order different from the supposed order in the PDL data corresponding to the printed material. In this case, it is considered that the possibility the inspection results become OK is faint even by performing the print processing again by using the same PDL data, and therefore, it is determined that recovery is not possible.

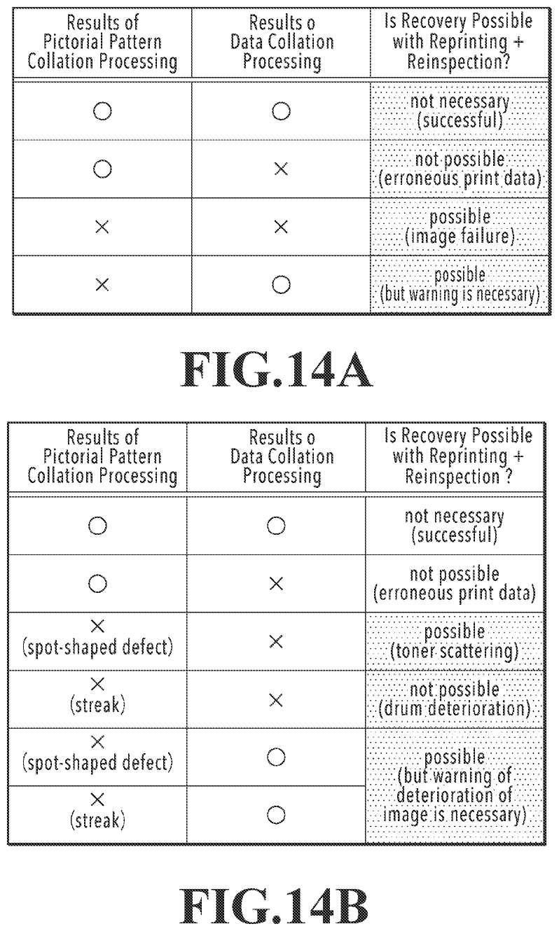

The above is the contents of the recovery possibility determination processing. FIG. 14A is a table putting together the determination results at S1201 and S1202. For example, it may also be possible to add an item indicating the results of the above-described recovery possibility determination processing on the inspection results display screen shown in FIG. 11 described previously and notify a user of the results. Further, in the present embodiment, in a case where it is determined that recovery is possible, the recovery processing is performed irrespective of the intention of a user, but it may also be possible to cause a user to determine whether to perform the recovery processing.

### Modification Example

It may also be possible to perform the determination at S1301 in the flowchart in FIG. 13 in more detail by taking whether the detected type of image defect is a spot-shaped defect or streak as a reference in accordance with the setting of the pictorial pattern inspection. Specifically, in a case where the detected defect is only a spot-shaped defect, the possibility that the defect results from a temporary phenomenon, such as scattering of toner, is strong, and therefore, control is performed so that the processing advances to S1302 by regarding the probability that the recovery processing causes the inspection to result in OK is high. On the other hand, in a case where a streak is included in the detected defect, the possibility that the defect results from a constant phenomenon is strong, such as deterioration of the photoconductor drum 303, and therefore, control may be performed so that the processing advances to S1303 by regarding the probability that the recovery processing causes the inspection to result in OK is low. FIG. 14B is a table putting together the determination results at S1201 and 1202 according to the present modification example.

As above, according to the present embodiment, it is possible to control the inspection system so as to perform printing and inspection again only in a case where recovery is possible in accordance with the results of both the pictorial pattern inspection and the data inspection. Due to this, it is possible to expect the effect of improvement of the recovery accuracy in addition to the effect of the first embodiment, and therefore, it is possible to contribute to the improvement of the productivity of a printed material.

### Other Embodiment

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

According to the present disclosure, in an inspection system of a printed material, it is made possible to deal with both an image defect and a data defect.

While the present disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2023-048477, filed Mar. 24, 2023, which is hereby incorporated by reference herein in its entirety.

What is claimed is:

1. An inspection apparatus configured to perform inspection of a printed material output from a printing apparatus, the inspection apparatus comprising:
one or more memories storing instructions; and
one or more processors, wherein the instructions, when executed by the one or more processors, cause the inspection apparatus to perform:
obtaining an inspection image which is to be inspected by reading the printed material;
detecting an image defect by first collation collating a reference image taken as a reference of the inspection, which corresponds to the printed material, with the inspection image; and
detecting a data defect by second collation collating specific data extracted from the inspection image with correct data corresponding to the specific data set in advance.

2. The inspection apparatus according to claim 1, wherein
the instructions, when executed by the one or more processors, cause the inspection apparatus to perform:
determining whether or not recovery processing to perform printing and inspection again for obtaining a new printed material which is alternative of the printed material is possible based on results of the first collation and results of the second collation.

3. The inspection apparatus according to claim 2, wherein
in the determining, in a case where an image defect is detected by the first collation, the recovery processing is determined to be possible irrespective of whether a data defect is detected by the second collation.

4. The inspection apparatus according to claim 3, wherein
in the determining, in a case where an image defect is not detected by the first collation and a data defect is detected by the second collation, the recovery processing is determined to be not possible.

5. The inspection apparatus according to claim 2, wherein
the instructions, when executed by the one or more processors, cause the inspection apparatus to perform:
causing a display unit to display a UI screen indicating results of the determination.

6. The inspection apparatus according to claim 5, wherein
on the UI screen, results of the first collation and results of the second collation are further indicated.

7. The inspection apparatus according to claim 5, wherein
the UI screen is configured so as to be capable of receiving instructions by a user as to whether the recovery processing is performed.

8. The inspection apparatus according to claim 5, wherein
in a case where the recovery processing is determined to be possible, on a condition that an image defect is detected by the first collation and a data defect is not detected by the second collation, a warning to the effect that there is a possibility that an image defect is detected from a printed material obtained by the recovery processing is displayed on the UI screen.

9. The inspection apparatus according to claim 1, wherein
the specific data is data of a character string included in the printed material, and
correct data corresponding to the specific data is data indicating a character string to be printed in the printed material.

10. The inspection apparatus according to claim 1, wherein
the specific data is data of a barcode included in the printed material, and
correct data corresponding to the specific data is data indicating a character string that should have been encoded by a barcode to be printed in the printed material.

11. An inspection system of a printed material, the inspection system comprising:
a printing apparatus configured to perform print processing based on image data; and
an inspection apparatus configured to perform inspection for a printed material for which print processing has been performed in the printing apparatus, the inspection apparatus comprising:
one or more memories storing instructions; and
one or more processors, wherein the instructions, when executed by the one or more processors, cause the inspection apparatus to perform:
obtaining an inspection image which is to be inspected by reading the printed material;
detecting an image defect by first collation collating a reference image taken as a reference of the inspection, which corresponds to the printed material, with the inspection image;
detecting a data defect by second collation collating specific data extracted from the inspection image with correct data corresponding to the specific data set in advance; and
determining whether or not recovery processing to perform printing and inspection again for the printed material is possible based on results of the first collation and results of the second collation, wherein
the printing apparatus performs print processing again using image data of the printed material in a case where the recovery processing is determined to be possible in the determining, and
the inspection apparatus performs again the obtaining an inspection image, the detecting an image defect, the detecting a data defect, and the determining for a printed material obtained by the print processing performed again.

12. An inspection method of performing inspection of a printed material output from a printing apparatus, the inspection method comprising:
obtaining an inspection image which is to be inspected by reading the printed material;
detecting an image defect by collating a reference image taken as a reference of the inspection, which corresponds to the printed material, with the inspection image; and
detecting a data defect by collating specific data extracted from the inspection image with correct data corresponding to the specific data set in advance.

13. A non-transitory computer-readable storage medium storing one or more programs including instructions, which when executed by one or more processors of an inspection apparatus, cause the inspection apparatus to perform an inspection method of performing inspection of a printed material output from a printing apparatus, the inspection method comprising:
obtaining an inspection image which is to be inspected by reading the printed material;
detecting an image defect by collating a reference image taken as a reference of the inspection, which corresponds to the printed material, with the inspection image; and
detecting a data defect by collating specific data extracted from the inspection image with correct data corresponding to the specific data set in advance.
